(19) United States
(12) Patent Application Publication
(10) Pub. No.: US 2008/0102658 A1
(43) Pub. Date: May 1, 2008

(54) Printed circuit board assembly having a multitude of terminals

(76) Inventor: Jin Ho Kim, Hwaseong-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/648,885

(22) Filed: Dec. 29, 2006

(30) Foreign Application Priority Data
Oct. 27, 2006 (KR) 10-2006-0105257

(51) Int. Cl. H01R 12/00

(52) U.S. Cl. 439/79

(57) ABSTRACT

A PCB assembly includes a PCB; a holder attached to the PCB and including a plurality of holes; and a plurality of terminals disposed in the holes of the holder, each comprising a portion substantially parallel to and attached to a surface of the PCB. The PCB may include a pin fixing hole, and the holder may include a guide pin disposed in the pin fixing hole. The portion of each terminal that is attached to the PCB may be soldered onto the surface of the PCB. The holder may be injection molded around the terminals. The PCB may include a sensor or a switch.

### CROSS-REFERENCE TO RELATED APPLICATION

This application claims priority to and benefit of Korean Patent application NO. 2006-0105257, filed on Oct. 27, 2006, in the Korean Intellectual Property Office, the disclosure of which is incorporated herein by reference.

### BACKGROUND OF THE INVENTION

1. Field of the Invention

The present invention relates to a printed circuit board (PCB) assembly, and more particularly to a PCB assembly with a compact structure.

2. Description of the Related Art

In general, a vehicle is provided with a number of sensors and switches in connection with movement of the vehicle, Installation space is limited. Therefore, sensors and switches installed in vehicles are relatively smaller than sensors and switches of other machines.

The sensor and the switch for vehicles each includes a PCB provided in a relatively small housing. Maximizing an effective mount area for electrical elements is a key feature of an optimum design.

Furthermore, the number of elements which are to be attached to the PCB is increasing as multi-function sensors and switches are used. Therefore, the electrical element mount area required in the PCB is increasing and also the number of terminals for power input and signal input/output is increasing.

A conventional PCB assembly includes a connector housing, a PCB on which a number of elements such as a LEDs, etc. are attached, a PCB supporting housing, and an upper cover. A connector is connected to the connector housing when installed therein. The PCB is electrically connected to the connector.

A number of holes are formed in the PCB, and one end of each terminal is inserted into one of the holes, and subsequently the terminal is fixed by soldering the element mounted surface.

However, if the holes are formed on the PCB, then the effective mount area of the element mounted surface for the electrical element will be decreased correspondingly. In particular, sensors and switches for vehicles are small, and thus the area of the holes for the terminals is relatively large in the PCB. Therefore, an increase of the holes is largely responsible for the decrease of in the effective mount area of the PCB.

The decrease of the effective mount area is also an obstacle to the miniaturization of the part. Further, the terminals have to be connected to the PCB independently, and thus automation is hard to achieve.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a PCB assembly having a number of terminals fixed therein and shaped such that the reduction of the effective mount area is decreased, and the process of attaching the terminals to the PCB is improved.

An embodiment of the present invention provides a PCB with a pin fixing hole; a holder that has a guide pin inserted in the pin fixing hole, and a plurality of holes; and a plurality of terminals that are inserted in the holes of the holder and extend backward, and that are bent parallel to the PCB at their end facing the back surface of the PCB and forming a PCB contact, wherein the holder has a structure fixed in the PCB with the terminal is inserted therein.

The PCB contact may be soldered in a back surface of the PCB. The holder may be injection molded around the terminals. The PCB may include a sensor or a switch.

The features and advantages of the present invention will be fully understood and appreciated from the following detailed description and the accompanying drawings.

### BRIEF DESCRIPTION OF THE DRAWINGS

FIG. 1 is a part view of a switch provided with a PCB assembly according to an embodiment of the present invention,

FIG. 2 is an exploded perspective view of a PCB assembly according to an embodiment of the present invention, and

FIG. 3 is an assembled perspective view of a PCB assembly according to an embodiment of the present invention.

### DETAILED DESCRITPION OF THE PREFERRED EMBODIMENTS

Hereinafter, the present invention will be described with reference to the accompanying drawings.

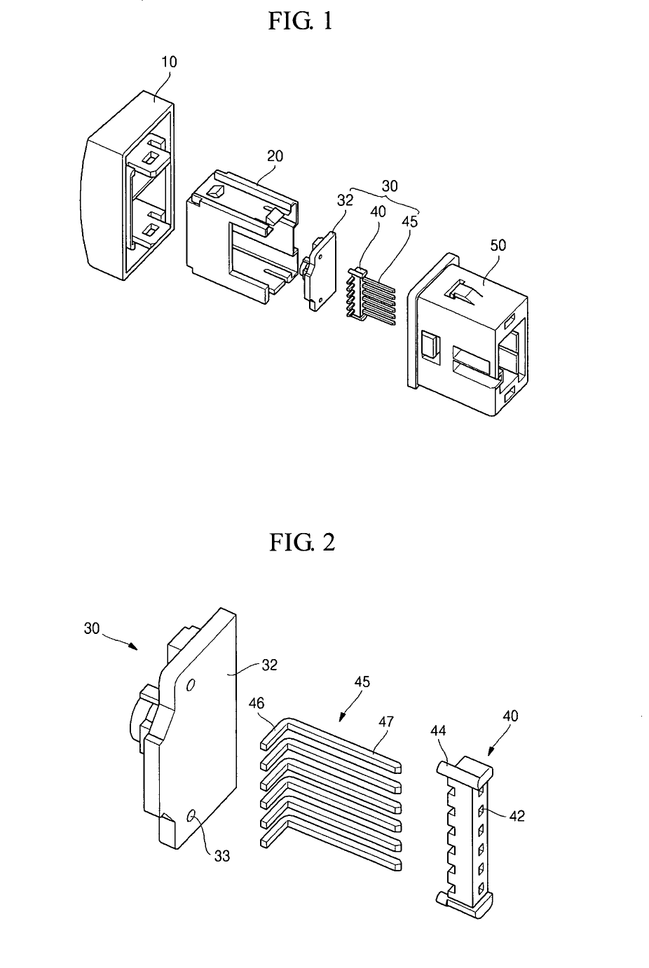

Referring FIG. 1, a PCB assembly comprises a button housing 10, a moving housing 20, a PCB assembly 30 and a connector housing 50. The PCB assembly 30 comprises a PCB 32, a holder 40 and terminals 45.

The terminals 45 are inserted into a terminal recess of a connector which is inserted and engaged with the connector housing 50.

The switch may be installed in the instrument panel with the button housing 10 revealed in the front direction so that the user may operate the switch, and the connector housing 50 is disposed into the panel and connected to the connector. The operation of the button housing 10 is transferred to the PCB assembly 30 through the moving housing 20. The PCB assembly 30 is electrically connected to the connector via the terminals 45.

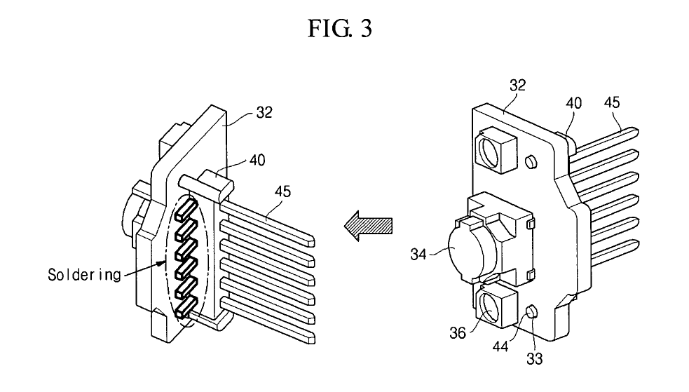

The electrical elements are mounted on the front surface of the PCB 32, as shown in FIG. 3, and the surface comprises a switching part 34 and an LED 36. A sensor may be attached to the surface. Further, the fixing hole 33 is formed on the PCB 32 in which the guide pin 44 of the holder is inserted. Two guide pins 44 are formed on the side ends of the holder 40.

A plurality of holes, in which the terminals 45 are inserted, are formed on the holder 40.

The terminals 45 comprise a power input terminal and a signal input/output terminal. Each terminal 45 has a PCB contact 46 which is bent in the shape of a ‘L’ and is parallel with the back surface of the PCB 32, and an extension 47 which is bent in the perpendicular direction with respect to the PCB contact 46 and is extended into the connector housing 50 through the perforating hole 42.

The holder 40 and the terminals 45 are connected by inserting the terminals 45 into the holes 42 of the holder 40 with the PCB contact 46 parallel to the back surface of the PCB 32. The guide pin 44 of the holder 46 is inserted into the pin fixing hole 33 of the PCB 32 with the terminal 45 engaged therein.

The PCB contacts 46 of the terminals 45 are soldered onto the back surface of the PCB. A conductive pattern was already formed on the back surface of the PCB by, for example, an etching process, at the region that the PCB contact 46 is soldered. Therefore, an electrical connection is achieved by soldering.

The terminal 45 and the holder 40 may be formed together by injection molding. The terminals 45 are inserted in a holder mold before the holder is formed. Therefore, it is possible to omit an assembly process of the terminal 45 and the holder 40.

The holder 40 and the PCB 32 are assembled to each other by interference-fitting the guide pin 44 of the holder 40 into the pin fixing hole 33 of the PCB 32, and the terminals 45 are electrically connected to corresponding elements of the PCB 32 by soldering the PCB contact 46 of the terminal 45 onto the backside of the PCB 32, and thus it is possible to connect a large number of terminals 45 such that the number of holes perforating the PCB 32 is minimized.

Furthermore, a constant supporting force between the PCB 32 and the terminal 45 is obtained because the holder 40 supporting the terminal 45 is fixed by an interference fit between the guide pin 44 and the pin fixing hole 33.

Furthermore, the process of soldering the terminal 45 onto the back surface of the PCB 32 is automated with relative ease.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A PCB assembly, comprising:
a PCB;
a holder attached to the PCB and comprising a plurality of holes; and
a plurality of terminals disposed in the holes of the holder, each comprising a portion substantially parallel to and attached to a surface of the PCB.

2. The PCB assembly according to claim 1, wherein the PCB comprises a pin fixing hole, and the holder comprises a guide pin disposed in the pin fixing hole.

3. The PCB assembly according to claim 1, wherein the portion of each terminal is soldered onto the surface of the PCB.

4. The PCB according to claim 1, wherein the holder is injection molded around the terminals.

5. The PCB assembly according to claim 1, wherein the PCB comprises a sensor or a switch.
